(19) United States
(12) Patent Application Publication
(10) Pub. No.: US 2005/0287410 A1
(43) Pub. Date: Dec. 29, 2005

(54) Polymer electrolyte membrane and fuel cell using the same

(75) Inventors: Shin Saito, Tsukuba-shi (JP); Hiroshi Shinoda, Tsukuba-shi (JP); Daizaburo Yashiki, Tsukuba-shi (JP); Katsuhiko Iwasaki, Tsukuba-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Sumitomo Chemical Company, Limited

(21) Appl. No.: 11/167,794

(22) Filed: Jun. 27, 2005

(30) Foreign Application Priority Data
Jun. 29, 2004 (JP) 2004-190892

(51) Int. Cl. H01M 8/10

(52) U.S. Cl. 429/33

(57) ABSTRACT

A polymer electrolyte membrane having excellent mechanical natures is provided. The polymer electrolyte membrane has an elastic modulus at 23° C. and a relative humidity of 50% of 400 MPa to 900 MPa and comprises at least one polymer, all of which have an aromatic ring on their main chain, at least one of which has an aliphatic chain on its main chain and at least one of which is a polymer electrolyte.

### BACKGROUND OF THE INVENTION

The present invention relates to a polymer electrolyte membrane, and more specifically, a polymer electrolyte membrane having specific elastic modulus.

Recently, there are various trials investigating energy sources showing small environmental load. Among these, fuel cell, particularly a solid polymer electrolyte type fuel cell using a solid polymer electrolyte membrane is expected to be applied as a power source for automobiles and the like because of a merit of a discharged substance composed only of water, and the like.

The polymer electrolyte membrane for the solid polymer electrolyte type fuel cell includes membranes obtained from polymer electrolytes such as perfluoroalkylsulfonic acids and the like typified by Nafion (registered trade mark of DuPont), however, there are pointed out problems that cost is very high, heat resistance is low, it is not practical unless reinforcement is performed due to low membrane strength, and the like.

On the other hand, development of cheap polymer electrolytes capable of substituting for the above-mentioned polymer electrolyte is recently activated. Particularly, polymers obtained by introducing a sulfonic acid group into an aromatic polyether excellent in heat resistance and having high film strength, namely, aromatic polymers having a sulfonate group on its side chain and having an aromatic main chain are promising, and for example, sulfonated polyether ketone-based polymers (JP-A No. 11-502249) and sulfonated polyether sulfone-based polymers (JP-A No. 10-45913, JP-A No. 10-21943) are suggested.

Here, the polymer electrolyte membrane is sandwiched by separators, gaskets, gas diffusion layers and the like in a fuel cell stack, and is under high plane pressure. Under such conditions, the water absorption of the membrane varies to case dimension change in changing of electric current and activation and stopping thereof, therefore, requirement properties of the polymer electrolyte membrane for fuel cell include high durability against expansion and shrinkage in water absorption and drying.

Consequently, there is suggested a polymer electrolyte membrane having improved mechanical natures. For example, suggestions for improvement of film folding resistance include a membrane having an elastic modulus of 2400 to 5400 MPa obtained by adding polyethylene glycol or its derivative into a sulfonated polyarylene (JP-A No. 2002-008440), a complex membrane having an elastic modulus of 3300 to 5400 MPa obtained by laminating a sulfonated polyarylene membrane and a tetrafluoroethylene copolymer membrane (JP-A No. 2002-008447), and a membrane having an elastic modulus of 170 to 270 MPa or 350 MPa made of a fluorine-containing copolymer (JP-A No. 2002-008447, JP-A No. 11-329062).

However, these polymer electrolyte membranes have a problem that mechanical durability in a stack is still insufficient.

### BRIEF SUMMARY OF THE INVENTION

The present inventors have intensively investigated to find a polymer electrolyte membrane having more excellent mechanical natures and resultantly found that a specific polymer electrolyte membrane having a specific elastic modulus of 400 MPa to 900 MPa at 23° C. and a relative humidity of 50% manifests excellent mechanical durability even in fuel cell stacks and the like, completing the present invention.

Namely, the present invention provides

[1] A polymer electrolyte membrane having an elastic modulus at 23° C. and a relative humidity of 50% of 400 MPa to 900 MPa and comprising one or more polymers, all of which have an aromatic ring on their main chain, at least one of which has an aliphatic chain on its main chain and at least one of which is a polymer electrolyte.

Further, the present invention provides

[2] The polymer electrolyte membrane according to [1], wherein the ion exchange capacity of the polymer electrolyte membrane is 0.2 to 4 meq/g.

Also, the present invention provides

[3] The polymer electrolyte membrane according to [1] or [2], wherein the polymer electrolyte has at least a unit of the following general formula (1) or at least a unit of the following general formula (2) and a unit of the following general formula (3), as a repeating unit:
—[(Ar¹)ₙ—R¹—(Ar²)ₘ—X¹]— (1)
wherein R¹ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, Ar¹ and Ar² represent each independently a group selected from phenylene groups optionally carrying a substituent, biphenylylene groups optionally carrying a substituent, triphenylene groups optionally carrying a substituent and naphthylene groups optionally carrying a substituent, and at least one of R¹, Ar¹ and Ar² has an ion exchange group, X¹ represents any of a direct bond, —O—, —S—, —CO—, —SO— and —SO₂—, n and m represent 0 or 1, and n+m is 1 or 2.):
—[(Ar³)ₒ—R²—(Ar⁴)ₚ—X²]— (2)
—(Ar⁵-Z¹-Ar⁶-Z²)- (3)
wherein R² represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, Ar³, Ar⁴, Ar⁵ and Ar⁶ represent each independently a group selected from phenylene groups optionally carrying a substituent, biphenylylene groups optionally carrying a substituent, triphenylene groups optionally carrying a substituent and naphthylene groups optionally carrying a substituent, and at least one of Ar⁵ and Ar⁶ has an ion exchange group, X², Z¹ and Z² represent each independently any of a direct bond, —O—, —S—, —CO—, —SO— and —SO₂—, o and p represent each independently 0 or 1.

Further, the present invention provides

[4] The polymer electrolyte membrane according to [3], wherein the ion exchange group is an acid group selected from —SO₃H, —PO(OH)₂, —COOH and —SO₂NHSO₂—.

Further, the present invention provides

[5] The polymer electrolyte membrane according to any of [1] to [4], wherein the main chain in the polymer electrolyte is a block copolymer composed of an aromatic segment and an aliphatic segment.

The present invention provides

[6] The polymer electrolyte membrane according to any of [1] to [5] comprising a polymer non-electrolyte having at least a unit of the following general formula (4) or a polymer non-electrolyte having at least a unit of the following general formula (5) and a unit of the following general formula (6), as a repeating unit:
—[(Ar⁷)_{q}—R³—(Ar⁸)ᵣ—X³]— (4)
wherein R³ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, and Ar⁷ and Ar⁸ represent each independently a group selected from phenylene groups optionally carrying a substituent, biphenylylene groups optionally carrying a substituent, triphenylene groups optionally carrying a substituent and naphthylene groups optionally carrying a substituent, X³ represents any of a direct bond, —O—, —S—, —CO—, —SO— and —SO₂—, q and r represent 0 or 1, and q+r is 1 or 2.):
—(R⁴—X⁴)— (5)
—(Ar⁹Z³-Ar¹⁰-Z⁴)- (6)
wherein R⁴ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, and Ar⁹ and Ar¹⁰ represent each independently a group selected from phenylene groups optionally carrying a substituent, biphenylylene groups optionally carrying a substituent, triphenylene groups optionally carrying a substituent and naphthylene groups optionally carrying a substituent, and X⁴, Z³ and Z⁴ represent each independently any of a direct bond, —O—, —S—, —CO—, —SO— and —SO₂—.

The present invention provides

[7] The polymer electrolyte membrane according to [6], wherein the polymer non-electrolyte is a block copolymer.

The present invention provides

[8] A fuel cell using the polymer electrolyte membrane according to any of [1] to [7].

The polymer electrolyte membrane of the present invention shows excellent mechanical durability since it has an elastic modulus at 23° C. and a relative humidity of 50% of 400 MPa to 900 MPa and comprises polymers wherein all of which have an aromatic ring on its main chain, at least one of which has an aliphatic chain on its main chain and at least one of which is a polymer electrolyte.

### DETAILED DESCRIPTION OF THE INVENTION

The present invention will be illustrated in detail below.

The polymer electrolyte membrane of the present invention is characterized in that it has an elastic modulus at 23° C. and a relative humidity of 50% of 400 MPa to 900 MPa. When the elastic modulus is too low, there is a fear of creeping of the membrane in a fuel cell stack. Therefore, it is preferably 500 MPa or more, further preferably 550 MPa or more, particularly preferably 600 MPa or more. When the elastic modulus is too high, the fragility of the membrane increases. Therefore, it is preferably 870 MPa or less, further preferably 840 MPa or less, particularly preferably 800 MPa or less.

The polymer electrolyte membrane of the present invention is characterized in that it comprises one or more polymers, all of which have an aromatic ring on their main chain, at least one of which has an aliphatic chain in its main chain and at least one of which is a polymer electrolyte. The polymer electrolyte membrane may comprise one or more polymers, all of which are polymer electrolytes. Alternatively the polymers may be a mixture of one or more polymer electrolytes and one or more polymers which are not an electrolyte (hereinafter abbreviated as polymer non-electrolyte).

In the present invention, these polymer electrolytes and polymer non-electrolytes are those wherein all have an aromatic ring in their main chain and at least one of which has an aliphatic chain in its main chain. The case where both an aromatic ring and an aliphatic chain is present in the main chain of a polymer electrolyte is preferable. Particularly, the case where the main chain is a block copolymer of an aromatic segment and an aliphatic segment is preferable. Here, when a polymer electrolyte having no aromatic ring in its main chain and/or a polymer non-electrolyte is contained in the polymers, there is an undesirable tendency that the polymer electrolyte membrane has lower glass transition temperature and poor heat resistance and the water resistance of the membrane lowers.

These polymer electrolyte and polymer non-electrolyte have a molecular weight of usually about 1000 to 1000000 represented by the number-average molecular weight in terms of polystyrene.

Here, when the number-average molecular weight is smaller than 1000, the membrane strength tends to lower, therefore, it is preferably 5000 or more, more preferably 20000 or more. When the number-average molecular weight is larger than 1000000, there is a tendency that dissolution thereof into a solvent needs a longer time or solution viscosity increases too much, leading to difficult membrane formation, therefore, it is preferably 500000 or less, more preferably 300000 or less.

The polymer electrolyte includes polymers having a cation exchange group such as —SO₃H, —COOH, —PO(OH)₂, —P(OH₂), —SO₂NHSO₂—, —Ph(OH) (Ph represents a phenylene group) and the like or an anion exchange group such as —NH₂, —NHR, —NRR′, —NRR′R″⁺, —NH₃⁺ and the like (wherein, R, R′ and R″ represent an alkyl group, cycloalkyl group, aryl group and the like), for example, as the ion exchange group. Such an ion exchange group may be introduced directly into an aromatic ring constituting the main chain of a polymer or introduced into a substituent, side chain and the like on an aromatic ring or on an aliphatic chain constituting the main chain.

Part or all of these ion exchange groups may form a salt with a counter ion, and when actually used as a polymer electrolyte membrane for fuel cell, the case in which it is a cation exchange group, namely, an acid group, is preferable, and the case in which substantially all acid groups are a free acid is preferable.

Preferable acid groups include —SO₃H, —PO(OH)₂, —COOH, —SO₂NHSO₂— and the like. More preferable acid groups include —SO₃H and —PO(OH)₂, and particularly, —SO₃H is preferable.

As the polymer electrolyte of the polymer electrolyte membrane of the present invention, there are usually used those having such an ion exchange capacity that a polymer electrolyte membrane using this has an ion exchange capacity of about 0.2 to 4 meq/g.

Here, when the ion exchange capacity of a polymer electrolyte membrane is over 4 meq/g, water resistance tends to lower, therefore, it is preferably 3 meq/g or less, more preferably 2.5 meq/g or less. When the ion exchange capacity of a polymer electrolyte membrane is lower than 0.2 meq/g, there is a tendency that the ion conductivity of the membrane lowers and output as a fuel cell decreases, therefore, it is preferably 0.5 meq/g or more, more preferably 0.8 meq/g or more. Therefore, when the polymer electrolyte membrane contains a polymer non-electrolyte, the polymer electrolyte is selected from those having an ion exchange capacity having usually about 0.2 to 5.0 meq/g, preferably about 0.5 to 4.0 meq/g, more preferably about 1.0 to 3.0 meq/g. When a polymer non-electrolyte is not contained, the polymer electrolyte is selected from those having an ion exchange capacity in the range described above for a polymer electrolyte membrane.

The polymer electrolyte membrane of the present invention is composed of the polymer electrolyte as described above or of this and a polymer non-electrolyte, and listed as suitably used polymer electrolytes are those having at least a unit of the following general formula (1) or having at least a unit of the following general formula (2) and a unit of the following general formula (3), for example, as a repeating unit:
—[(Ar¹)ₙ—R¹—(Ar²)ₘ—X¹]— (1)
wherein R¹ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, Ar¹ and Ar² represent each independently a group selected from phenylene groups optionally carrying a substituent, biphenylylene groups optionally carrying a substituent, triphenylene groups optionally carrying a substituent and naphthylene groups optionally carrying a substituent, and at least any of R¹, Ar¹ and Ar² have an ion exchange group, X¹ represents any of a direct bond, —O—, —S—, —CO—, —SO—and —SO₂—, n and m represent 0 or 1, and n+m is 1 or 2;
—[(Ar³)ₒ—R²—(Ar⁴)ₚ—X²]— (2)
—(Ar⁵-Z¹-Ar⁶-Z²)- (3)
wherein R² represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, Ar³, Ar⁴, Ar⁵ and Ar⁶ represent each independently a group selected from phenylene groups optionally carrying a substituent, biphenylylene groups optionally carrying a substituent, triphenylene groups optionally carrying a substituent and naphthylene groups optionally carrying a substituent, and at least any of Ar⁵ and Ar⁶ have an ion exchange group, X², Z¹ and Z² represent each independently any of a direct bond, —O—, —S—, —CO—, —SO— and —SO₂—, o and p represent each independently 0 or 1.

In the polymer electrolyte membrane of the present invention, listed as suitably used polymer non-electrolytes are those having at least a unit of the following general formula (4) or having at least a unit of the following general formula (5) and a unit of the following general formula (6), for example, as a repeating unit:
—[(Ar⁷)_{q}—R³—(Ar⁸)ᵣ—X³]— (4)
wherein R³ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, and Ar⁷ and Ar⁸ represent each independently a group selected from phenylene groups optionally carrying a substituent, biphenylylene groups optionally carrying a substituent, triphenylene groups optionally carrying a substituent and naphthylene groups optionally carrying a substituent, X³ represents any of a direct bond, —O—, —S—, —CO—, —SO— and —SO₂—, q and r represent 0 or 1, and q+r is 1 or 2;
—(R⁴—X⁴)— (5)
—(Ar⁹-Z³-Ar¹⁰-Z⁴)- (6)
wherein R⁴ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, and Ar⁹ and Ar¹⁰ represent each independently a group selected from phenylene groups optionally carrying a substituent, biphenylylene groups optionally carrying a substituent, triphenylene groups optionally carrying a substituent and naphthylene groups optionally carrying a substituent, and X⁴, Z³ and Z⁴ represent each independently any of a direct bond, —O—, —S—, —Co—, —SO— and —SO₂—.).

Here, examples of the alkylene group having 2 to 10 carbon atoms optionally carrying a substituent include an ethylene group, propylene group, butylene group, pentylene group, hexylene group, heptylene group, octylene group, nonylene group, decamethylene group and the like, and additionally, those obtained by substitution on these groups with an alkyl group having 1 to 6 carbon atoms such as methyl, ethyl, n-propyl and the like, an alkoxy group having 1 to 6 carbon atoms such as methoxy, ethoxy, n-propoxy and the like, a halogenated alkyl group having 1 to 6 carbon atoms such as trifluoromethyl and the like, a halogenated alkoxy group having 1 to 6 carbon atoms such as trifluoromethoxy and the like, an aryl group having 6 to 14 carbon atoms such as phenyl, naphthyl and the like, an aryloxy group having 6 to 14 carbon atoms such as phenoxy, naphthyloxy and the like, an acetyl group, a benzoyl group, a halogeno group such as fluoro, chloro, bromo and the like, a hydroxyl group, and the like. When there are a plurality of substituents, they may be the same or different.

Of them, alkylene groups having 2 to 10 carbon atoms with a substituted halogeno group are preferable, and more preferable are partially halogenated alkylene groups having 2 to 10 carbon atoms such as a 2,2,3,3,4,4-hexafluoropentylene group, 2,2,3,3,4,4,5,5,6,6-decafluoroheptylene group and the like, per-halogenated alkylene groups having 2 to 10 carbon atoms such as a 1,1,2-trifluoro-2-chloroethylene group, tetrafluoroethylene group, octafluorobutylene group, dodecafluorohexylene group, hexadecafluorooctylene group and the like. Particularly preferable are a tetrafluoroethylene group, octafluorobutylene group, dodecafluorohexylene group, hexadecafluorooctylene group and the like.

Examples of the oxyalkylene group having 2 to 10 carbon atoms optionally carrying a substituent include an oxyethylene group, oxypropylene group, oxybutylene group, oxypentylene group, oxyhexylene group, oxyheptylene group, oxyoctylene group, oxynonylene group, oxydecamethylene group and the like, and additionally, those obtained by substitution on these groups with an alkyl group having 1 to 6 carbon atoms such as methyl, ethyl, n-propyl and the like, an alkoxy group having 1 to 6 carbon atoms such as methoxy, ethoxy, n-propoxy and the like, a halogenated alkyl group having 1 to 6 carbon atoms such as trifluoromethyl and the like, a halogenated alkoxy group having 1 to 6 carbon atoms such as trifluoromethoxy and the like, an aryl group having 6 to 14 carbon atoms such as phenyl, naphthyl and the like, an aryloxy group having 6 to 14 carbon atoms such as phenoxy, naphthyloxy and the like, an acetyl group, a benzoyl group, a halogeno group such as fluoro, chloro, bromo and the like, a hydroxyl group, and the like. When there are a plurality of substituents, they may be the same or different.

Of them, oxyalkylene groups having 2 to 10 carbon atoms carrying a substituted halogeno group are preferable, and more preferable are partially halogenated oxyalkylene groups having 2 to 10 carbon atoms such as an oxy-(2,2,3,3,4,4-hexafluoro)pentylene group, oxy-(2,2,3,3,4,4,5,5,6,6-decafluoro)heptylene group and the like, per-halogenated oxyalkylene groups having 2 to 10 carbon atoms such as an oxy-(1,1,2-trifluoro-2-chloro)ethylene group, oxy-(tetrafluoro)ethylene group, oxy-(octafluoro)butylene group, oxy-(dodecafluoro)hexylene group, oxy-(hexadecafluoro)octylene group and the like. Particularly preferable are an oxy-(tetrafluoro)ethylene group, oxy-(octafluoro)butylene group, oxy-(dodecafluoro)hexylene group, oxy-(hexadecafluoro)octylene group and the like.

Examples of the oxyalkyleneoxy group having 2 to 10 carbon atoms optionally carrying a substituent include an oxyethyleneoxy group, oxypropyleneoxy group, oxybutyleneoxy group, oxypentyleneoxy group, oxyhexyleneoxy group, oxyheptyleneoxy group, oxyoctyleneoxy group, oxynonyleneoxy group, oxydecamethyleneoxy group and the like, and additionally, those obtained by substitution on these groups with an alkyl group having 1 to 6 carbon atoms such as methyl, ethyl, n-propyl and the like, an alkoxy group having 1 to 6 carbon atoms such as methoxy, ethoxy, n-propoxy and the like, a halogenated alkyl group having 1 to 6 carbon atoms such as trifluoromethyl and the like, a halogenated alkoxy group having 1 to 6 carbon atoms such as trifluoromethoxy and the like, an aryl group having 6 to 14 carbon atoms such as phenyl, naphthyl and the like, an aryloxy group having 6 to 14 carbon atoms such as phenoxy, naphthyloxy and the like, an acetyl group, a benzoyl group, a halogeno group such as fluoro, chloro, bromo and the like, a hydroxyl group, and the like. When there are a plurality of substituents, they may be the same or different.

Of them, oxyalkyleneoxy groups having 2 to 10 carbon atoms carrying a substituted halogeno group are preferable, and more preferable are partially halogenated oxyalkyleneoxy groups having 2 to 10 carbon atoms such as an oxy-(2,2,3,3,4,4-hexafluoro)pentylene-oxy group, oxy-(2,2,3,3,4,4,5,5,6,6-decafluoro)heptylene-oxy group and the like, per-halogenated oxyalkyleneoxy groups having 2 to 10 carbon atoms such as an oxy-(1,1,2-trifluoro-2-chloro)ethylene-oxy group, oxy-(tetrafluoro)ethylene-oxy group, oxy-(octafluoro)butylene-oxy group, oxy-(dodecafluoro)hexylene-oxy group, oxy-(hexadecafluoro)octylene-oxy group and the like. Particularly preferable are an oxy-(tetrafluoro)ethylene-oxy group, oxy-(octafluoro)butylene-oxy group, oxy-(dodecafluoro)hexylene-oxy group, oxy-(hexadecafluoro)octylene-oxy group and the like.

Examples of the substituent on the phenylene group optionally carrying a substituent, biphenylylene group optionally carrying a substituent and triphenylene group optionally carrying a substituent include alkyl groups having 1 to 6 carbon atoms such as methyl, ethyl, n-propyl and the like, alkoxy groups having 1 to 6 carbon atoms such as methoxy, ethoxy, n-propoxy and the like, halogenated alkyl groups having 1 to 6 carbon atoms such as trifluoromethyl and the like, halogenated alkoxy groups having 1 to 6 carbon atoms such as trifluoromethoxy and the like, aryl groups having 6 to 14 carbon atoms such as phenyl, naphthyl and the like, aryloxy group having 6 to 14 carbon atoms such as phenoxy, naphthyloxy and the like, acetyl group, benzoyl group, halogeno groups such as fluoro, chloro, bromo and the like, hydroxyl group, and the like.

Preferable examples of the phenylene group optionally carrying a substituent include a 1,4-phenylene group, 1,3-phenylene group, 1,2-phenylene group and those obtained by substitution on these groups with an alkyl group having 1 to 6 carbon atoms such as methyl, ethyl, n-propyl and the like, an alkoxy group having 1 to 6 carbon atoms such as methoxy, ethoxy, n-propoxy and the like, a halogenated alkyl group having 1 to 6 carbon atoms such as trifluoromethyl and the like, a halogenated alkoxy group having 1 to 6 carbon atoms such as trifluoromethoxy and the like, an aryl group having 6 to 14 carbon atoms such as phenyl, naphthyl and the like, an aryloxy group having 6 to 14 carbon atoms such as phenoxy, naphthyloxy and the like, an acetyl group, a benzoyl group, a halogeno group such as fluoro, chloro, bromo and the like, a hydroxyl group, and the like. When there are a plurality of substituents, they may be the same or different. Of them, a 1,4-phenylene group optionally substituted with these substituents is preferable.

Preferable examples of the biphenylylene group optionally carrying a substituent include a 4,4′-biphenylene biphenylylene group, 3,3′-biphenylene biphenylylene group, 3,4′-biphenylene biphenylylene group and those obtained by substitution on these groups with an alkyl group having 1 to 6 carbon atoms such as methyl, ethyl, n-propyl and the like, an alkoxy group having 1 to 6 carbon atoms such as methoxy, ethoxy, n-propoxy and the like, a halogenated alkyl group having 1 to 6 carbon atoms such as trifluoromethyl and the like, a halogenated alkoxy group having 1 to 6 carbon atoms such as trifluoromethoxy and the like, an aryl group having 6 to 14 carbon atoms such as phenyl, naphthyl and the like, an aryloxy group having 6 to 14 carbon atoms such as phenoxy, naphthyloxy and the like, an acetyl group, a benzoyl group, a halogeno group such as fluoro, chloro, bromo and the like, a hydroxyl group, and the like. When there are a plurality of substituents, they may be the same or different. Of them, a 4,4′-biphenylene biphenylylene group optionally substituted with these substituents is preferable.

Preferable examples of the triphenylene group optionally carrying a substituent include a 4,4″-triphenylene group, 3,3″-triphenylene group, 3,4″-triphenylene group and those obtained by substitution on these groups with an alkyl group having 1 to 6 carbon atoms such as methyl, ethyl, n-propyl and the like, an alkoxy group having 1 to 6 carbon atoms such as methoxy, ethoxy, n-propoxy and the like, a halogenated alkyl group having 1 to 6 carbon atoms such as trifluoromethyl and the like, a halogenated alkoxy group having 1 to 6 carbon atoms such as trifluoromethoxy and the like, an aryl group having 6 to 14 carbon atoms such as phenyl, naphthyl and the like, an aryloxy group having 6 to 14 carbon atoms such as phenoxy, naphthyloxy and the like, an acetyl group, a benzoyl group, a halogeno group such as fluoro, chloro, bromo and the like, a hydroxyl group, and the like. When there are a plurality of substituents, they may be the same or different. Of them, a 4,4″-triphenylene group optionally substituted with these substituents is preferable.

Preferable examples of the naphthylene group optionally carrying a substituent include a 1,4-naphthylene group, 2,3-naphthylene group, 1,5-naphthylene group, 2,6-naphthylene group, 2,7-naphthylene group, 1,8-naphthylene group and those obtained by substitution on these groups with an alkyl group having 1 to 6 carbon atoms such as methyl, ethyl, n-propyl and the like, an alkoxy group having 1 to 6 carbon atoms such as methoxy, ethoxy, n-propoxy and the like, a halogenated alkyl group having 1 to 6 carbon atoms such as trifluoromethyl and the like, a halogenated alkoxy group having 1 to 6 carbon atoms such as trifluoromethoxy and the like, an aryl group having 6 to 14 carbon atoms such as phenyl, naphthyl and the like, an aryloxy group having 6 to 14 carbon atoms such as phenoxy, naphthyloxy and the like, an acetyl group, a benzoyl group, a halogeno group such as fluoro, chloro, bromo and the like, a hydroxyl group, and the like. When there are a plurality of substituents, they may be the same or different. Of them, a 1,4-naphthylene group, 1,5-naphthylene group, 2,6-naphthylene group and 2,7-naphthylene group optionally substituted with these substituents are preferable.

Typical examples of the unit of the general formula (1) include, for example, the following units depicted in the form of free acid. Here, ks represent each independently 0, 1 or 2, and at least one of ks in each unit is 1 or 2.

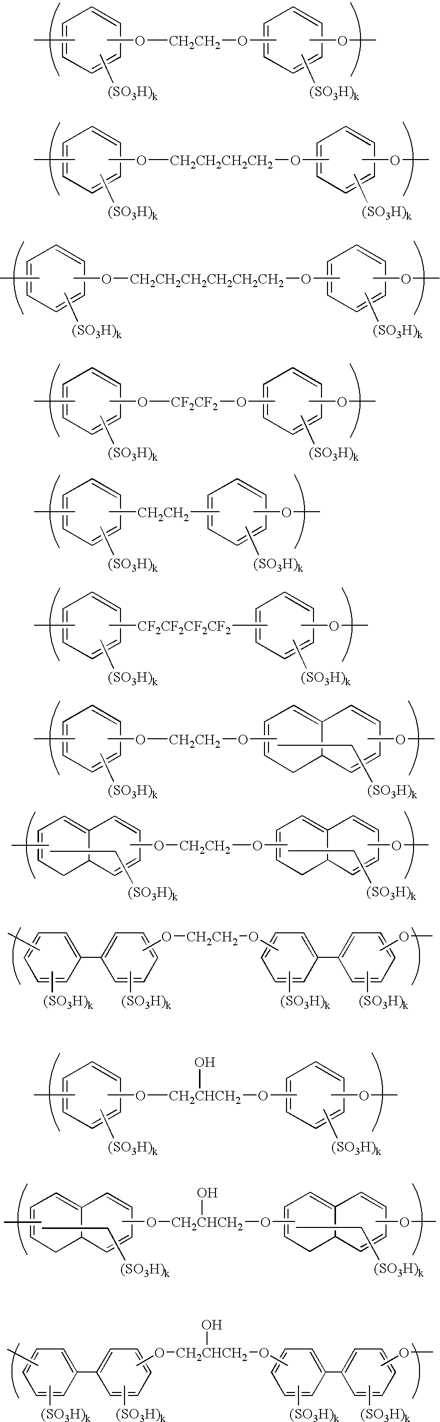

Specific examples of the unit of the general formula (2) include, for example, the following units.

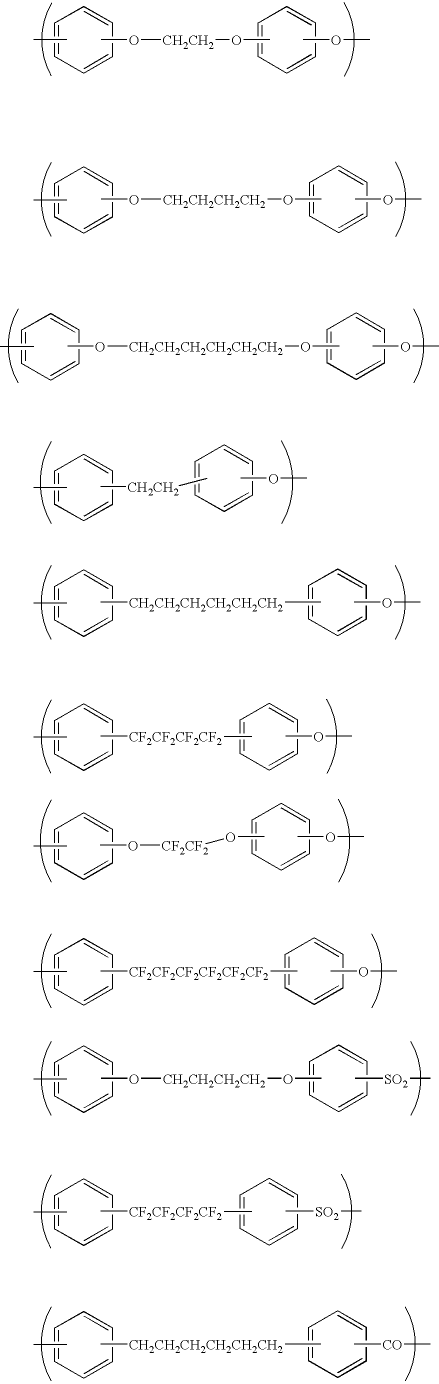

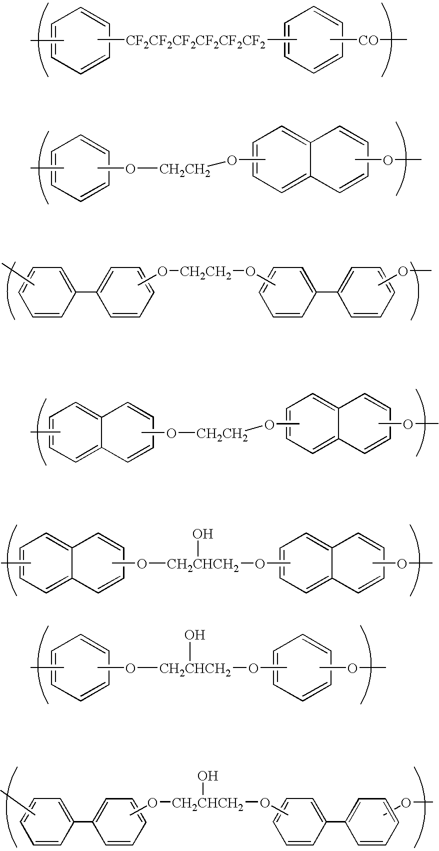

Specific examples of the unit of the general formula (3) include, for example, the following units depicted in the form of free acid.

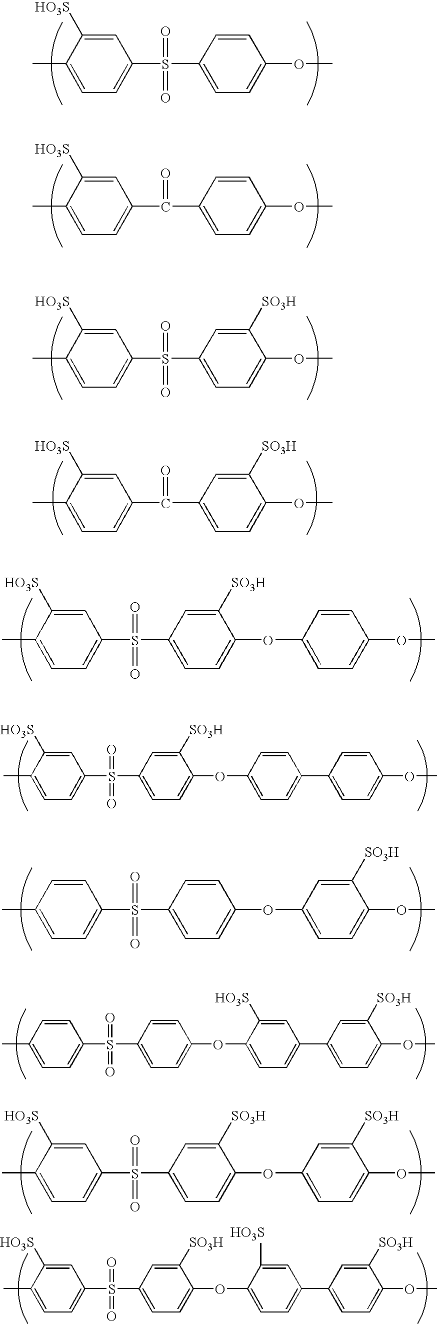

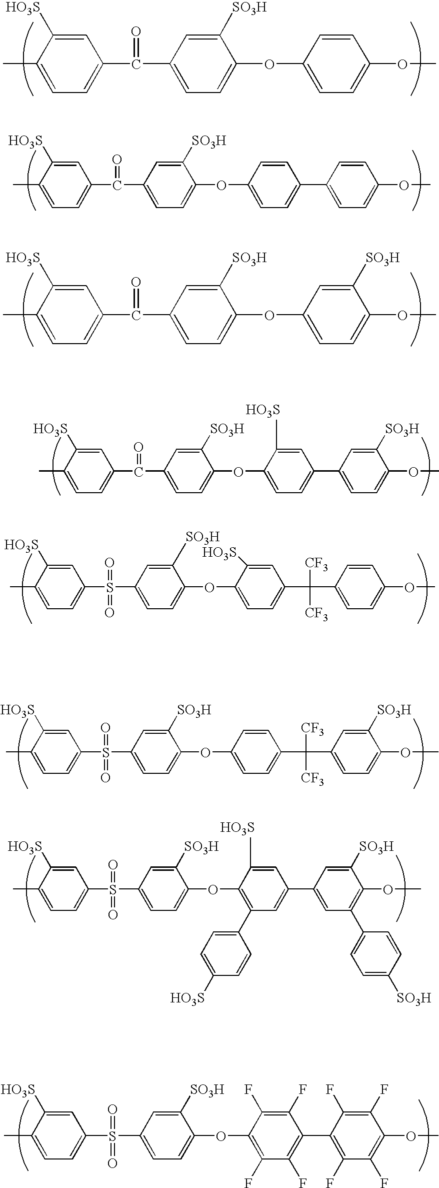

Specific examples of the unit of the general formula (4) include, for example, the following units.

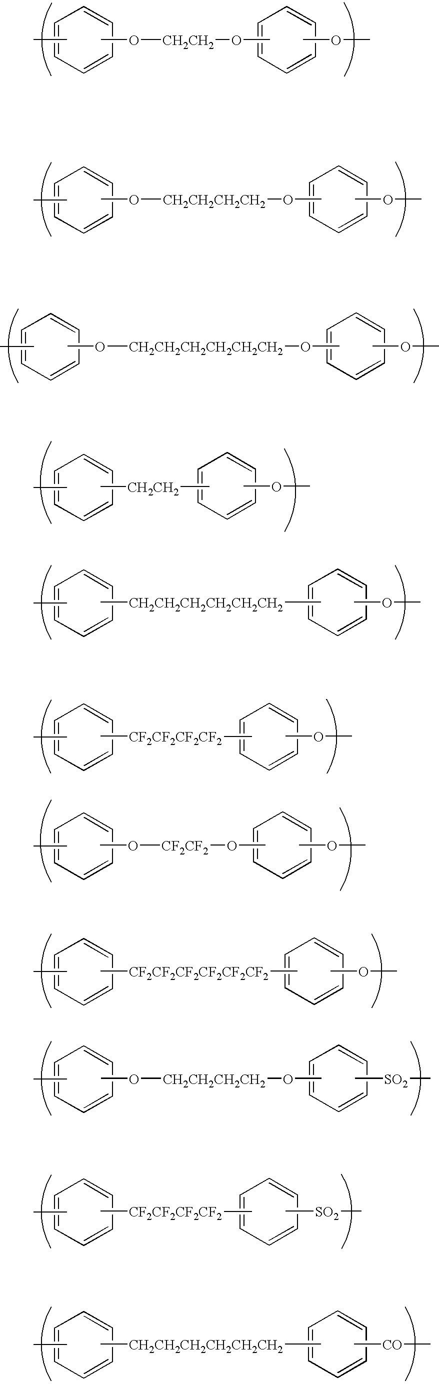

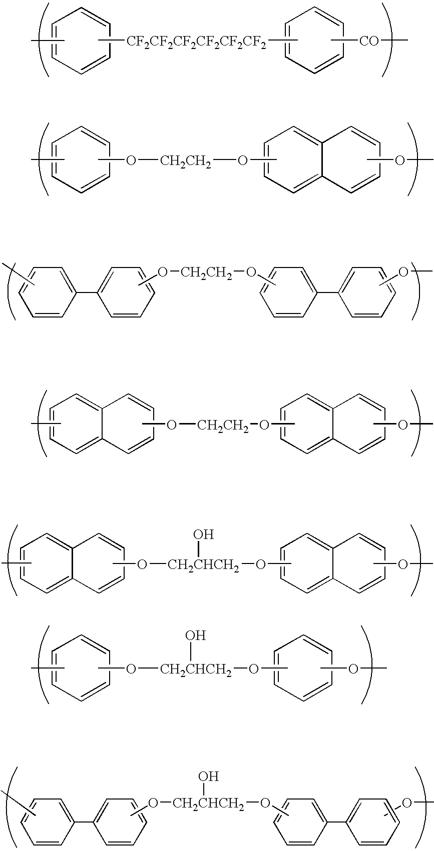

Specific examples of the unit of the general formula (5) include, for example, the following units. [symbol]
CH₂CH₂—O [symbol] [symbol] CH₂CH₂CH₂CH₂—O [symbol] [symbol] CH₂CH₂CH₂CH₂CH₂CH₂—O [symbol] [symbol]
CF₂CF₂—O [symbol] [symbol] CF₂CF₂CF₂CF₂—O [symbol] [symbol] CF₂CF₂CF₂CF₂CF₂CF₂—O

[symbol]

Specific examples of the unit of the general formula (6) include, for example, the following units.

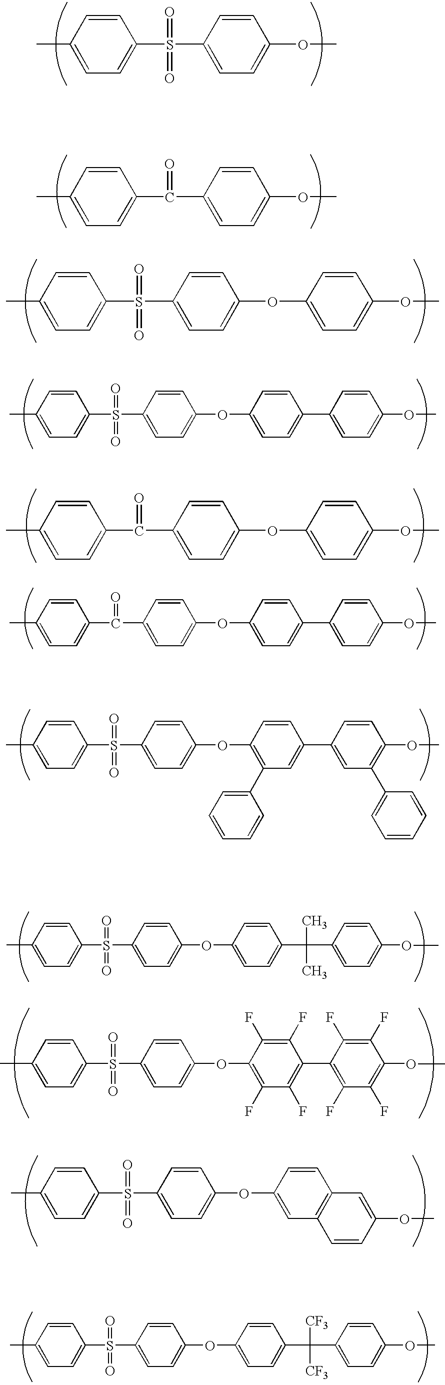

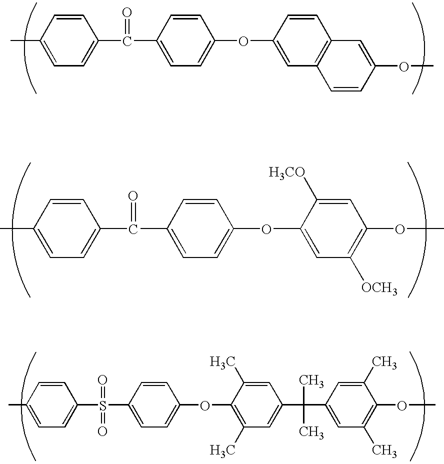

The polymer electrolyte suitably used in the present invention include those having at least a repeating unit of the general formula (1) as described above, and those having at least a repeating unit of the general formula (2) as described above and a repeating unit of the general formula (3) as described above, and the like, and the polymer electrolyte can further contains other repeating units. When a plurality of repeating units is contained, it may be an alternating copolymer, random copolymer, block copolymer or graft copolymer.

The polymer non-electrolyte suitably used in the present invention include those having at least a repeating unit of the general formula (4) as described above, and those having at least a repeating unit of the general formula (5) as described above and a repeating unit of the general formula (6) as described above, and the like, and the polymer non-electrolyte can further contains other repeating units. When a plurality of repeating units is contained, it may be an alternating copolymer, random copolymer, block copolymer or graft copolymer.

The polymer electrolyte and polymer non-electrolyte in the present invention can be produced by known methods such as, for example, condensing of a corresponding dihalogeno compound and a corresponding diol compound in a solvent in the presence of an alkali, and the like.

Specifically, a polymer electrolyte of the following general formula (7) can be produced by poly-condensing 1,6-bis(4-fuorophenyl)-dodecafluorohexane, 4,4′-dihydroxybiphenyl and 4,4′-difluoro-3,3′-disulfodiphenylsulfone in the presence of an alkali. A polymer non-electrolyte of the following general formula (8) can be produced by reacting a polyethylene oxide having a hydroxyl group at the chain end and a polyether sulfone having both ends fluorinated.

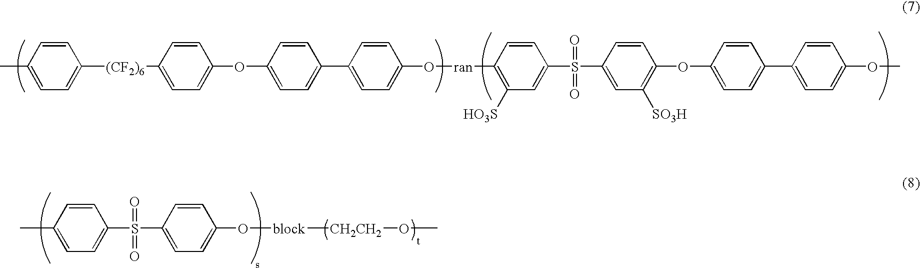

The polymer electrolyte membrane in the present invention may contain the polymer non-electrolytes as described above in addition to the polymer electrolytes as described above, as the constituent polymer, and the combination thereof is not particularly restricted, and it may be a polymer electrolyte membrane constituted of only one polymer electrolyte, or a polymer electrolyte constituted of a plurality of polymer electrolytes and a plurality of polymer non-electrolytes.

In producing such a polymer electrolyte membrane, the production method is not particularly restricted, and a method of forming a membrane from solution condition (solution cast method) is preferably used.

Specifically, a polymer electrolyte and a polymer non-electrolyte used if necessary are dissolved in a suitable solvent, the solution is applied by flow casting on a glass plate, and the solvent is removed to form a polymer electrolyte membrane. The solvent used in membrane formation is not particularly restricted providing it can dissolve a polymer electrolyte and a polymer non-electrolyte used if necessary and subsequently the solvent can be removed, and suitably used are aprotic polar solvents such as N,N-dimethylformamide, N,N-dimethylacetamide (DMAc), N-methyl-2-pyrrolidone, dimethylsulfoxide and the like, chlorinated solvents such as dichloromethane, chloroform, 1,2-dichloroethane, chlorobenzene, dichlorobenzene and the like, alcohols such as methanol, ethanol, propanol and the like, alkylene glycol monoalkyl ethers such as ethylene glycol monomethyl ether, ethylene glycol monoethyl ether, propylene glycol monomethyl ether, propylene glycol monoethyl ether, and the like. These can be used singly and, if necessary, two or more solvents can also be used in combination. Of them, dimethylformamide, dimethylacetamide, N-methylpyrrolidone, dimethylsulfoxide and the like are preferable because of high solubility of a polymer.

The polymer electrolyte membrane of the present invention may be a composite membrane obtained by methods such as impregnation conjugation with a porous film or sheet (porous membrane) or mixing with a fibrous polymer, and the like.

Namely, a composite membrane can be obtained by impregnation conjugation of a polymer electrolyte and/or polymer non-electrolyte as a constituent component of a polymer electrolyte membrane of the present invention with a porous film or sheet (porous membrane) made of at least one polymer electrolyte and/or polymer non-electrolyte, wherein the polymer electrolyte and/or polymer non-electrolyte are impregnated and the polymer electrolyte and/or non-electrolyte of the film or sheet are as defined above. In this case, it is preferable that a polymer non-electrolyte is contained in the porous film or sheet, and that a polymer electrolyte is used as a component to be impregnated.

A composite membrane can be obtained by film formation by mixing a polymer electrolyte and/or polymer non-electrolyte as a constituent component of a polymer electrolyte membrane of the present invention with a fibrous substance made of at least one polymer electrolyte and/or polymer non-electrolyte, among constituent components of the polymer electrolyte membrane of the present invention. In this case, the case containing a polymer non-electrolyte of a fibrous substance is preferable, and it is preferable to contain a polymer electrolyte as a component to be mixed with a fibrous substance.

Here, since the porous membrane is used for further improvement in strength, flexibility and durability of a polymer electrolyte membrane, it can be used irrespective of its shape providing its purpose is satisfied, and when used as a partition wall of a polymer electrolyte fuel cell, the membrane thickness is usually 1 to 100 μm, preferably 3 to 30 μm, further preferably 5 to 20 μm, the pore diameter is usually 0.01 to 10 μm, preferably 0.02 to 7 μm, and the void ratio is usually 20 to 98%, preferably 30 to 95%. As the material of the porous membrane, a polymer non-electrolyte, and a polymer having an aliphatic chain in the main chain, is preferable. As the method of producing these porous membranes, known methods can be used.

Further, since the fibrous substance is used for further improvement in strength, flexibility and durability of a polymer electrolyte membrane, it can be used irrespective of its length, breadth and the like providing its use object is satisfied. When used as a partition wall of a polymer electrolyte fuel cell, the relative proportion of a fibrous substance occupying a polymer electrolyte membrane is preferably 0.1% to 20% by weight. As the material of the fibrous substance, a polymer non-electrolyte and, a polymer having an aliphatic chain in the main chain, are preferable. As the method for producing these fibrous substances, known methods can be used.

The method of conjugating such porous membranes and fibrous substances is not particularly restricted, and for example, there are mentioned a method in which a porous membrane is impregnated into a polymer electrolyte solution, the porous membrane is removed, then, the solvent is dried to obtain a composite membrane, a method in which a polymer electrolyte solution is applied on a porous membrane, and the solvent is dried to obtain a composite membrane, a method in which a polymer electrolyte solution is allowed to contact a porous membrane under reduce pressure, thereafter, the pressure is returned to normal pressure to allow the solution to impregnate into pores in the porous membrane, and the solvent is dried to obtain a composite membrane, a method in which a fibrous substance and a polymer electrolyte solution are mixed, thereafter, membrane formation is effected according to the above-mentioned solution cast method, and the like.

Thus, a polymer electrolyte membrane is obtained, however, in the present invention, those having an elastic modulus at 23° C. and a relative humidity of 50% of 400 MPa to 900 MPa are selected.

Next, a fuel cell will be illustrated.

The fuel cell of the present invention can be produced by allowing a catalyst and an electrical conductive substance as a current collector to contact both surfaces of the polymer electrolyte membrane as described above.

The catalyst is not particularly restricted providing it can activate a redox reaction with hydrogen or oxygen, and known materials can be used, and platinum fine particles are preferably used. It is preferable that platinum fine particles are carried on activated carbon or carbon in the form of fiber or particle such as graphite and the like and used.

Also, as the electrical conductive substance as a current collector, known materials can be used, and porous carbon non-woven fabric or carbon paper is preferable since it transfers a raw material gas efficiently to a catalyst.

Here, regarding the method of allowing platinum fine particles or carbon carrying platinum fine particles to contact a porous carbon non-woven fabric or carbon paper and the method of allowing this to contact a polymer electrolyte membrane, known methods such as a method described, for example, in J. Electrochem. Soc.: Electrochemical Science and Technology, 1988, 135 (9), 2209, and the like can be used.

### EXAMPLES

The present invention will be illustrated further in detail by examples below, but the scope of the invention is not limited to them.

Elastic Modulus

Elastic modulus was measured by a tension test effected under 23° C. and a relative humidity of 50% according to Japanese Industrial Standards (JIS K 7127).

Dry-Humid Cycle Test

10 mg of a platinum catalyst carried on carbon (platinum carrying amount: 30%) was mixed with 0.1 ml of a lower alcohol solution (containing 10 wt % water)(manufactured by Aldrich) of Nafion (registered trade mark of Dupont) to give a paste which was applied on a porous carbon woven-fabric as an electrode material and dried to obtain a collector as an electrode material carrying fixed catalyst. These collectors were laminated on both surfaces of the membrane to obtain a membrane-electrode assembly. This membrane-electrode assembly was incorporated into a fuel cell.

A process of feeding humidified nitrogen passed through a bubbler kept at 95° C. for 30 minutes and feeding dry nitrogen not passed through a bubbler for 30 minutes onto both sides of anode and cathode of a fuel cell kept at 95° C. was one cycle. As an index for mechanical degradation of a membrane for this dry humid cycle, the hydrogen permeation amount of the membrane was used. When the number of cycles for attaining certain level of hydrogen permeation amount is larger, mechanical durability is higher.

The hydrogen permeation amount was measured by the following method. Hydrogen was fed to the anode side and nitrogen was fed to the cathode side of a fuel cell, and potentiostat/galvanostat was connected. First, the back pressure of both the electrodes was set at 1 atm (gauge reading), and the voltage was swept from 0.2 V to 0.6 V, and the current value (I_{b}) obtained in this procedure was recorded. Next, the back pressure of the cathode side was set at 0.5 atm (gauge reading) while maintaining the back pressure of the anode side, and the voltage was swept from 0.2 V to 0.6 V, and the current value (Iᵤ) obtained in this procedure was recorded. A difference in current between the case of equivalent back pressure and the case of differential pressure, namely, I_{b}-Iᵤ was converted into the volume of permeated hydrogen, which was used as a hydrogen permeation amount.

Viscosity Measurement

A polymer electrolyte was dissolved in N,N-dimethylformamide (DMF), to give a 0.01 g/mL solution. The specific viscosity of this solution was measured at 40° C. by a Ubbelohde type viscometer.

### Synthesis Example 1

### Synthesis Example of Random Copolymer (RC-1)

26.64 g of p-fluoroiodobenzene and 100 ml of dehydrated dimethylsulfoxide were charged in a flask under room temperature, and to this was added 15.24 g of a copper powder and the mixture was stirred at 110° C. Onto this, 30.46 g of 1,6-diiodododecafluorohexane was dropped slowly, and the mixture was stirred at 120° C. for 24 hours. The reaction solution was allowed to cool, then, filtrated, then, dropped into an aqueous solution to recover a deposited substance. The deposited substance was dissolved in acetone, filtrated, then, acetone was distilled off. The residue was dissolved in methanol, and allowed to deposit in water. The deposited substance was purified by distillation under reduced pressure (155° C., 5 mmHg), to obtain intended 1,6-bis(4-fluorophenyl)dodecafluorohexane (hereinafter, abbreviated as M-1). The NMR measurement results are shown below. ¹H-NMR (ppm): 7.49, 7.77, ¹⁹F-NMR (ppm): —108, −110, −122.

Next, 2 g of 4,4′-dihydroxybiphenyl, 1.559 g of potassium carbonate, 14 ml of N-methylpyrrolidone and 5 ml of toluene were added into the flask under nitrogen flow. Azeotropic dehydration was conducted while distilled toluene off at 180° C. Next, 2.634 g of the above-mentioned M-1 and 2.635 g of 4,4′-difluorodiphenylsulfone-3,3′-disulfonic acid, dipotassium salt were added, and the mixture was stirred at 180° C. for 8.5 hours. The reaction liquid after allowing to cool was dropped into methanol acidified with hydrochloric acid, the resulted precipitate was recovered by filtration and washed with methanol and water, then, dried under reduced pressure at 40° C. 5.82 g of a polymer electrolyte RC-1 of the following formula (9) as a random copolymer was obtained as a brown powder. The ion exchange group equivalent weight of the polymer electrolyte was measured by a titration method to find a value of 1.3 meq/mol. The specific viscosity of RC-1 was 1.25.

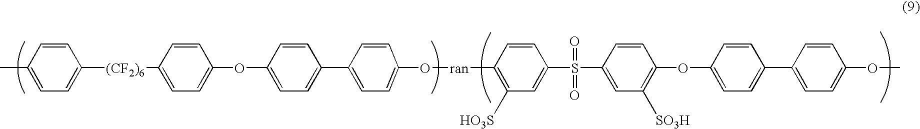

### Synthesis Example 2

### Synthesis Example of Polyether Sulfone (End-F Type)

Into a flask was added 1000 g of Sumika Excel PES4003P manufactured by Sumitomo Chemical Co., Ltd. (hydroxyl group-ended polyether sulfone, number-average molecular weight: 39000, manufactured by Sumitomo Chemical Co., Ltd.), 7.59 g of potassium carbonate, 2500 ml of DMAc and 500 ml of toluene under nitrogen and the mixture was heated at 160° C. and stirred for performing azeotropic dehydration. The solution was allowed to cool at room temperature, then, 53.6 g of decafluorobiphenyl was added and the mixture was heated and stirred at 80° C. for 3.5 hours. After allowing to cool, the reaction liquid was dropped into a large amount of water, and the resulted precipitate was recovered by filtration, and washed with a methanol/acetone mixed solvent, then, dried at 80° C. to obtain a polymer of the following general formula (10) carrying a F group at both ends (hereinafter, abbreviated as P-1).

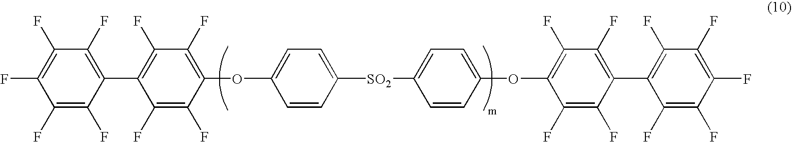

### Synthesis Example 3

### Synthesis Example of Block Copolymer Using Polyethylene Oxide (Hereinafter Abbreviated as PEO) and Polyether Sulfone (Hereinafter Abbreviated as PES)

15 g of PEO having a molecular weight of 70000 carrying a hydroxyl group at the chain end was dissolved in 20 ml of DMAc, 5 ml of toluene was added to this and azeotropic dehydration was conducted, then, the solution was allowed to cool to room temperature. To this was added 30 mg of oily NaH (60 wt %) and the mixture was stirred, to convert the chain end hydroxyl group into a sodium salt. Further, 5 g of the above-mentioned P-1 was added and the stirred to obtain an intended block copolymer. This block copolymer solution was poured into methanol, and a polymer of the following formula (11) (hereinafter, abbreviated as BC-1) was removed. The weight ratio of segments was calculated by ¹H•NMR measurement to find PES:PEO=1.0:1.9.

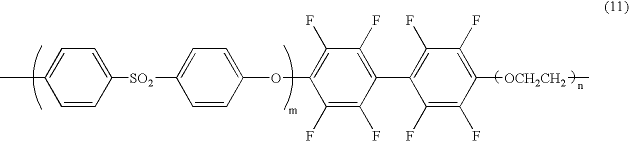

### Synthesis Example 4

### Synthesis Example of poly(oxy(3,3′-diphenyl-4,4′-biphenylylene)oxy-4,4′-biphenylylene) (Both End-OH Type)

Into a flask was added 22.12 g of 3,3′-diphenyl-4,4′-dihydroxybiphenyl, 19.26 g of 4,4′-dibromobiphenyl, 80 g of benzophenone and 20 ml of toluene under nitrogen and the mixture was stirred and dissolved. To this was added 9.49 g of potassium carbonate, and the mixture was heated and stirred and dehydrated under conditions of azeotrope of toluene and water, then, toluene was removed by distillation. Further, 5 ml of cuprous chloride/quinoline catalyst (0.1 g/10 ml) previously prepared was added, and the mixture was heated and stirred at 210° C. for 6 hours. The reaction liquid was poured into a large amount of methanol acidified with acetic acid, and the resulted precipitate was filtrated and dried to obtain a polymer of the following formula (12) carrying a hydroxyl group on both ends (hereinafter, abbreviated as P-2).

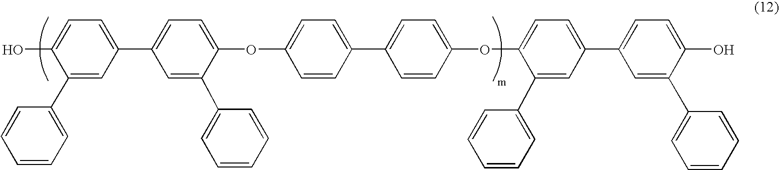

### Synthesis Example 5

### Synthesis Example of Block Copolymer (BC-2)

Into a flask was added 100 g of P-2 synthesized according to conditions in Synthesis Example 4, 8.29 g of potassium carbonate, 3000 ml of DMAc and 250 ml of toluene, and the mixture was heated and stirred at 150° C. to perform azeotropic dehydration. The mixture was allowed to cool to room temperature, then, 400 g of P-1 synthesized according to conditions in Synthesis Example 2 was added and the mixture was heated and stirred at 80° C. for 6 hours. After allowing to cool, the reaction liquid was dropped into a large amount of methanol acidified with hydrochloric acid, and the resulted precipitate was recovered by filtration and dried at 80° C. to obtain a block copolymer. The resulted block copolymer was dissolved in concentrated sulfuric acid and a sulfonation reaction was conducted at 60° C. The resulted solution was dropped into a large amount of ice water, and the precipitate was recovered by filtration. Further, mixer washing with ion exchange water was repeated until the washing liquid became neutral, then, dried, to obtained a block copolymer BC-2 sulfonated of the following formula (13). ¹H-NMR measurement of BC-2 in a DMSO-d6 solvent was conducted, as a result, signals derived from sulfonated substances of PES described in the following Reference Example 1 were not substantially observed, therefore, it was confirmed that a sulfonate group was not substantially introduced into a segment derived from P-1 and introduced selectively into a segment derived from P-2. The weight ratio of segments was calculated by ¹H HNR measurement to find (PES):(sulfonic acid substituted P-2)=2.0:1.0. The ion exchange group equivalent weight of the polymer electrolyte was measured by a titration method to find a value of 1.5 meq/mol. The relative viscosity thereof was 1.03.

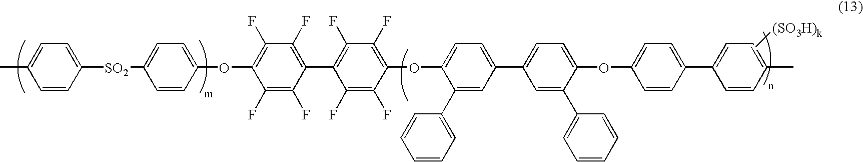

In the above formula, k means a number of introduced sulfonate group per repeating unit derived from P-2.

### Synthesis Example 6

### Synthesis Example of Block Copolymer (BC-3)

0.2 g of anhydrous ferric chloride and 1 ml of propylene oxide was stirred in 4 ml of ether at 0° C. for 10 minutes, then, the temperature was raised up to room temperature, and ether and volatile components were removed under reduced pressure to prepare a catalyst. To this was added 17.74 g of phenylglycidyl ether and 2.37 g of epichlorohydrin, and the mixture was heated and stirred at 100° C. for 1 hour and at 160° C. for 8 hours. The polymerization reaction mixture was poured into methanol to give a precipitate which was filtrated and dried, to obtain a polymer of poly(phenylglycidyl ether-co-epichlorohydrin) (hereinafter, abbreviated as GE2).

8 g of Sumika Excel PES5003P (hydroxyl group-ended polyether sulfone, manufactured by Sumitomo Chemical Co., Ltd.) and 0.1 g of potassium carbonate were dissolved in 40 ml of DMAc and 5 ml of toluene, and the solution was heated to distill toluene off. To this was added 2 g of GE2 and the mixture was heated and stirred at 160° C. for 3.5 hours. The reaction liquid was poured into dilute hydrochloric acid to deposit a polymer which was filtrated, washed with water and dried to recover a block copolymer. The resulted block copolymer was mixed with 40 g of concentrated sulfuric acid and dissolved, then, a large amount of water was poured to deposit a polymer which was filtrated, washed with water and dried to obtain a sulfonated block copolymer (BC-3) of the following formula (14). The ion exchange group equivalent weight of the polymer electrolyte (BC-3) was measured by a titration method to find a value of 1.0 meq/mol. BC-3 contained a slight amount of gel and was not dissolved completely in various solvents, as a result, measurement of specific viscosity was difficult.

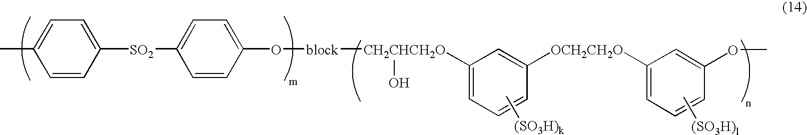

In the above formula, k and 1 mean a number of introduced sulfonate group per benzene ring.

### Synthesis Example 7

### Synthesis Example of Block Copolymer (BC-4)

A block copolymer BC-4 of the following formula (15) was obtained by synthesis according to the method described in Example 1 of JP-A No. 2001-250567. The ion exchange group equivalent weight of the polymer electrolyte was measured by a titration method to find a value of 1.6 meq/mol. BC-4 had a relative viscosity of 0.91.

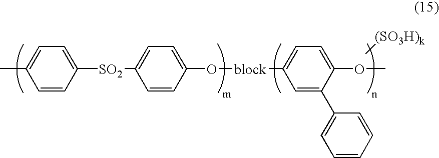

In the above formula, k means a number of introduced sulfonate group per repeating unit.

### Reference Example 1

1.5 g of Sumika Excel PES5200P (chloro group-ended polyether sulfone, manufactured by Sumitomo Chemical Co., Ltd.) was dissolved in 20 g of 10% fuming sulfuric acid and sulfonated at room temperature for 3 days. Thereafter, the sulfuric acid solution of the polymer was poured into ice water for dilution, and the dilute sulfuric acid solution of the polymer was dialyzed for 2 days in pure water flow through a dialysis membrane (UC36-32-100, manufactured by Sanko Junyaku K. K.) to remove sulfuric acid. The aqueous solution after dialysis was concentrated and dried to obtain sulfonated PES.

¹H-NMR measurement of sulfonated PES was conducted in a DMSO-d6 solvent, as a result, signals at 7.05 ppm, 7.90 ppm and 8.29 ppm which were not confirmed for PES5200P before sulfonation were observed, confirming introduction of a sulfonate group into an aromatic ring.

### Example 1

RC-1 obtained in Synthesis Example 1 was dissolved at a concentration of about 15 wt % into DMAc and the solution was cast on a glass plate, and dried at 80° C. to remove the solvent, to obtain a transparent and tough and flexible membrane. The ion exchange group equivalent weight of the polymer electrolyte was measured by a titration method to find a value of 1.3 meq/mol. The results of the dry humid cycle test and elastic modulus of this membrane are shown in Table 1.

### Example 2

BC-1 obtained in Synthesis Example 3 and BC-2 obtained in Synthesis Example 5 were weighed so that the weight ratio thereof was 1:2 and dissolved at a concentration of about 15 wt % in DMAc and cast on a glass plate, and dried at 80° C. to remove the solvent, to obtain a transparent and tough and flexible membrane. The ion exchange group equivalent weight of the membrane was measured by a titration method to find a value of 1.0 meq/mol. The results of the dry humid cycle test and elastic modulus of this membrane are shown in Table 1.

### Example 3

BC-3 obtained in Synthesis Example 6 was dissolved at a concentration of about 15 wt % in DMAc and cast on a glass plate, and dried at 80° C. to remove the solvent, to obtain a transparent and tough and flexible membrane. The ion exchange group equivalent weight of the membrane was measured by a titration method to find a value of 1.0 meq/mol. The results of the dry humid cycle test and elastic modulus of this membrane are shown in Table 1.

### Comparative Example 1

A transparent membrane was obtained by the same manner as in Example 2 except that BC-1 and BC-2 were weighed so that the weight ratio thereof was 2:1. The ion exchange group equivalent weight of the membrane was measured by a titration method to find a value of 0.5 meq/mol. The results of the dry humid cycle test and elastic modulus of this membrane are shown in Table 1.

### Comparative Example 2

BC-4 obtained in Synthesis Example 7 was dissolved at a concentration of about 15 wt % in DMAc and cast on a glass plate, and dried at 80° C. to remove the solvent, to obtain a transparent brown membrane. The ion exchange group equivalent weight of the membrane was measured by a titration method to find a value of 1.6 meq/mol. The results of the dry humid cycle test and elastic modulus of this membrane are shown in Table 1.

TABLE 1

| | | Number of cycles required |
|---|---|---|
| | Elastic modulus | for attaining 1 ml/min of |
| | (MPa) | hydrogen permeation amount |
| EXAMPLE 1 | 660 | 54 |
| EXAMPLE 2 | 587 | 112 |
| EXAMPLE 3 | 694 | >268 |
| COMPARATIVE | 320 | 4 |
| EXAMPLE 1 | | |
| COMPARATIVE | 958 | 6 |
| EXAMPLE 2 | | |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A polymer electrolyte membrane having an elastic modulus at 23° C. and a relative humidity of 50% of 400 MPa to 900 MPa and comprising at least one polymer each of which has an aromatic ring on its main chain, at least one of which has an aliphatic chain on its main chain and at least one of which is a polymer electrolyte.

2. The polymer electrolyte membrane according to claim 1, wherein the ion exchange capacity of the polymer electrolyte membrane is 0.2 to 4 meq/g.

3. The polymer electrolyte membrane according to claim 1, wherein the polymer electrolyte has at least a unit of the following general formula (1) or at least a unit of the following general formula (2) and a unit of the following general formula (3), as a repeating unit:
—[(Ar¹)ₙ—R¹—(Ar²)ₘ—X¹]— (1)
wherein R¹ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, Ar¹ and Ar² represent each independently a group selected from phenylene groups optionally carrying a substituent, biphenylylene groups optionally carrying a substituent, triphenylene groups optionally carrying a substituent and naphthylene groups optionally carrying a substituent, and at least one of R¹, Ar¹ and Ar² has an ion exchange group, X¹ represents any of a direct bond, —O—, —S—, —CO—, —SO— and —SO₂—, n and m represent 0 or 1, and n+m is 1 or 2;
—[(Ar³)ₒ—R²—(Ar⁴)ₚ—X²]— (2)
—(Ar⁵-Z¹-Ar⁶-Z²)- (3)
wherein R² represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, Ar³, Ar⁴, Ar⁵ and Ar⁶ represent each independently a group selected from phenylene groups optionally carrying a substituent, biphenylylene groups optionally carrying a substituent, triphenylene groups optionally carrying a substituent and naphthylene groups optionally carrying a substituent, and at least one of Ar⁵ and Ar⁶ has an ion exchange group, X², Z¹ and Z² represent each independently any of a direct bond, —O—, —S—, —CO—, —SO— and —SO₂—; o and p represent each independently 0 or 1.

4. The polymer electrolyte membrane according to claim 3, wherein the ion exchange group is an acid group selected from —SO₃H, —PO(OH)₂, —COOH and —SO₂NHSO₂—.

5. The polymer electrolyte membrane according to claim 1, wherein the main chain in the polymer electrolyte is a block copolymer composed of an aromatic segment and an aliphatic segment.

6. The polymer electrolyte membrane according to claim 1 comprising a polymer non-electrolyte having at least a unit of the following general formula (4) or a polymer non-electrolyte having at least a unit of the following general formula (5) and a unit of the following general formula (6), as a repeating unit:
—[(Ar⁷)_{q}—R³—(Ar⁸)ᵣ—X³]— (4)
wherein R³ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, and Ar⁷ and Ar⁸ represent each independently a group selected from phenylene groups optionally carrying a substituent, biphenylylene groups optionally carrying a substituent, triphenylene groups optionally carrying a substituent and naphthylene groups optionally carrying a substituent, X³ represents any of a direct bond, —O—, —S—, —CO—, —SO— and —SO₂—, q and r represent 0 or 1, and q+r is 1 or 2.):
—(R⁴—X⁴)— (5)
—(Ar⁹-Z³-Ar¹⁰-Z⁴)- (6)
wherein R⁴ represents a group selected from alkylene groups having 2 to 10 carbon atoms optionally carrying a substituent, oxyalkylene groups having 2 to 10 carbon atoms optionally carrying a substituent and oxyalkyleneoxy groups having 2 to 10 carbon atoms optionally carrying a substituent, and Ar⁹ and Ar¹⁰ represent each independently a group selected from phenylene groups optionally carrying a substituent, biphenylylene groups optionally carrying a substituent, triphenylene groups optionally carrying a substituent and naphthylene groups optionally carrying a substituent, and X⁴, Z³ and Z⁴ represent each independently any of a direct bond, —O—, —S—, —CO—, —SO— and —SO₂—.

7. The polymer electrolyte membrane according to claim 6, wherein the polymer non-electrolyte is a block copolymer.

8. A fuel cell using the polymer electrolyte membrane according to claim 1.
